(19) United States
(12) Patent Application Publication
(10) Pub. No.: US 2014/0132573 A1
(43) Pub. Date: May 15, 2014

(54) LIQUID CRYSTAL DISPLAY APPARATUS AND DRIVING METHOD

(71) Applicant: RAYDIUM SEMICONDUCTOR CORPORATION, Hsinchu City (TW)

(72) Inventors: WEN-TSUNG LIN, TAINAN CITY (TW); CHIEN-RU CHEN, TAINAN CITY (TW); YING-LIEH CHEN, TAINAN CITY (TW)

(73) Assignee: RAYDIUM SEMICONDUCTOR CORPORATION, HSINCHU CITY (TW)

(21) Appl. No.: 13/763,651

(22) Filed: Feb. 9, 2013

(30) Foreign Application Priority Data
Nov. 12, 2012 (TW) 101142090

(51) Int. Cl. G09G 3/36

(52) U.S. Cl. CPC G09G 3/3685
USPC 345/204; 345/98

(57) ABSTRACT

A driving method is disclosed, and the driving method is adopted to a liquid crystal display apparatus. The driving method includes steps as follows: receiving an original display data; rearranging the original display data to a new display data according to at least a scan driving mode; adjusting a sequence of scan driving so as to correspond to the scan driving mode according to a control signal; transmitting a new display data to a display panel through a data line, wherein the sequence of the original display data corresponds to the sequence of scan driving before adjusting, and a sequence of the new display data corresponds to the sequence of scan driving after adjusting according to the scan driving mode.

### BACKGROUND OF THE DISCLOSURE

1. Field of the Disclosure

The present disclosure relates to a driving method of a liquid crystal display apparatus; in particular, to a driving method related to improving an operating temperature.

2. Description of Related Art

With the progress in civilization, an image device has become a usual product in daily lives of people, and a display apparatus is an indispensable component of the image device. A user accesses data with the display apparatus, and even controls an operation of the image device through the display apparatus. In addition, a liquid crystal display, LCD, has been broadly applied to all kinds of products which are in need of a liquid crystal display apparatus due to advantages such as a less volume and weight, and a relatively low consumption of power; in recent years, there is even a trend of the liquid crystal display apparatus becoming a substitution for a cathode ray tube, CRT. The liquid crystal display apparatus has been broadly applied to televisions, notebooks, computers, mobile phones, personal digital assistants due to the advantages such as the less volume and weight, and the relatively low consumption of power.

However, with a size of a display panel getting bigger, then a resolution of the display panel is getting higher, and a RC loading of the display panel is also getting more, which leads to operating temperatures of all driving circuits also getting higher. Therefore, to economize a power consumption of driving a circuit to reduce the operation power possibly becomes an important issue.

### SUMMARY OF THE DISCLOSURE

The instant disclosure provides a liquid crystal display apparatus, and the liquid crystal display apparatus includes a display panel, a timing controller, a data driver, and a scan driver. The timing controller receives an original display data; and rearranges the original display data to be as a new display data according to at least a scan driving mode. The data driver is coupled to the timing controller, and the data driver receives the new display data and transmits the new display data to a display panel through a data line. The scan driver is coupled to the timing controller, and the scan driver receives a control signal transmitted by the timing controller, and adjusts a sequence of scan driving so as to correspond to the scan driving mode according to a control signal, wherein the sequence of the original display data corresponds to the sequence of scan driving before adjusting, and a sequence of the new display data corresponds to the sequence of scan driving after adjusting.

In an embodiment of the instant disclosure, when the timing controller rearranges the original display data to be as the new display data according to the scan driving mode, the timing controller transmits the control signal to the scan driver to adjust the sequence of scan driving according to the scan driving mode.

In the embodiment of the instant disclosure, the scan driver includes M scan sub-circuits, and the display panel is divided into M display blocks. According to the control signal, each of the scan sub-circuits transmits N scan driving signals to the display blocks corresponded, wherein M and N are positive integers.

In the embodiment of the instant disclosure, according to the control signal, each of the scan sub-circuits adjusts the sequence of scan driving so as to correspond to the scan driving mode.

In the embodiment of the instant disclosure, the timing controller further adjusts a sequence of display in the display blocks according to the data stored in a frame register.

The instant disclosure further provides a driving method, the driving method is applied to a liquid crystal display apparatus. The driving method includes steps as follows: receiving an original display data; rearranging the original display data to a new display data according to at least a scan driving mode; adjusting a sequence of scan driving so as to correspond to the scan driving mode according to a control signal; transmitting a new display data to a display panel through a data line, wherein the sequence of the original display data corresponds to the sequence of scan driving before adjusting, and a sequence of the new display data corresponds to the sequence of scan driving after adjusting according to the scan driving mode.

To sum up, the embodiments of the instant disclosure provide the liquid crystal display apparatus and the driving method thereof, which decreases a number of a high-low level voltage alteration without an image variation, and further reduces the operating temperature of the data driver.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

FIG. 1 shows a schematic diagram of a liquid crystal display apparatus according to an embodiment of the instant disclosure;

FIG. 2 shows a schematic diagram of a liquid crystal display apparatus according to another embodiment of the instant disclosure;

FIG. 3 shows a schematic diagram of a liquid crystal display apparatus according to another embodiment of the instant disclosure;

FIG. 4 shows a chart of a scan driving mode according to the embodiment of the instant disclosure;

FIG. 5 shows a schematic diagram of a timing controller rearranging an original display data according to the embodiment of the instant disclosure;

FIG. 6 shows a schematic diagram of the timing controller adjusting a sequence of scan driving according to the embodiment of the instant disclosure, and

FIG. 7 shows a flow chart of a driving mode according the embodiments of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the present disclosure. As used herein, the term “and/or” includes any and all combinations of one or more of the associated listed items.

### Embodiment of Liquid Crystal Display Apparatus

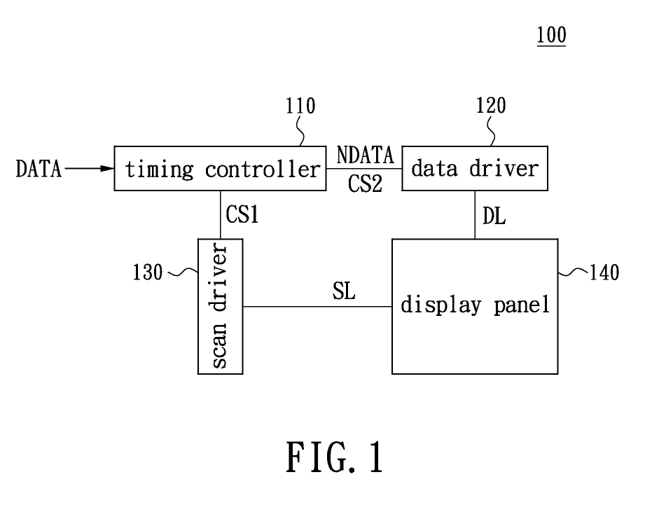

Referring to FIG. 1, FIG. 1 shows a schematic diagram of a liquid crystal display apparatus 100 according to an embodiment of the instant disclosure. In the present embodiment, the liquid crystal display apparatus 100 includes a timing controller 110, a data driver 120, a scan driver 130, and a display panel 140. The data driver 120 is coupled to the timing controller 110 and the display panel 140. The scan driver 130 is coupled to the timing controller 110 and the display panel 140.

In comparison to a high operating temperature of the prior arts, the instant disclosure provides a liquid crystal display apparatus 100 and the driving method thereof, which decreases a number of a high-low level voltage alteration without an image variation when the display panel 140 showing an image data, and further reduces the operating temperature of the data driver. In the present embodiment, the timing controller 110 receives an original display data DATA, and the timing controller 110 rearranges the original display data DATA to be as a new display data NDATA according to at least a scan driving mode, wherein in comparison to the original display data DATA, it is just the sequence difference from the new display data NDATA, but an visual effect shown on the display panel 140 does not change. It is to be noticed that the sequence of the original display data DATA corresponds to the sequence of scan driving before adjusting, and a sequence of the new display data NDATA corresponds to the sequence of scan driving after adjusting according to the scan driving mode by the timing controller 110. The scan driving mode in the instant disclosure is a mode that decreases a number of a high-low level voltage alteration related to the original display data DATA during the data driver 120 transmitting a data driving signal.

The data driver 120 is used to offer the data driving signal to the display panel 140 through a data line DL, wherein the data driving signal means a gray-scale voltage signal. The data driver 120 receives the new display data NDATA transmitted by the timing controller 110 and a control signal CS2, wherein the new display data NDATA corresponds to the data driving signal.

The scan driver 130 is used to offer the scan driving signal to the display panel 140 through the scan line SL. The scan driver 130 receives a control signal CS1 transmitted by the timing controller 110, and adjusts the sequence of scan driving so as to correspond to the scan driving mode according to the control signal CS1. When the timing controller 110 rearranges the original display data DATA according to the scan driving mode, the timing controller 110 also transmits the control signal CS1, according to the scan driving mode, to the scan driver 130 to adjust the sequence of scan driving of the scan driving signal.

Briefly, the timing controller 110 in the present embodiment of the instant disclosure is able to rearrange the sequence of the original display data DATA and to output the new display data NDATA to the data driver 120 according to the scan driving mode. In the meantime, the timing controller 110 transmits the control signal CS1 to the scan driver 130 according to the scan driving mode, and thus the scan driver 130 accordingly adjusts the sequence of scan driving of the scan driving signal. Surely, the sequence of scan driving of the scan driving signal after adjusting is corresponding to the sequence of the new display data NDATA, to make sure the visual effect shown on the display panel 140 does not change.

To specifically describe an operation flow of the liquid crystal display apparatus 100 in the present embodiment of the instant disclosure, there is at least an embodiment as follows for further instructions.

In the following embodiments, there are only descriptions different from the embodiment in the FIG. 1 to be recited, and the rest of the omitted parts are indicated to be identical to the embodiment in the FIG. 1. Moreover, for the convenience during instruction, similar numbers or similar symbols refer to alike elements.

### Embodiment of Another Liquid Crystal Display Apparatus

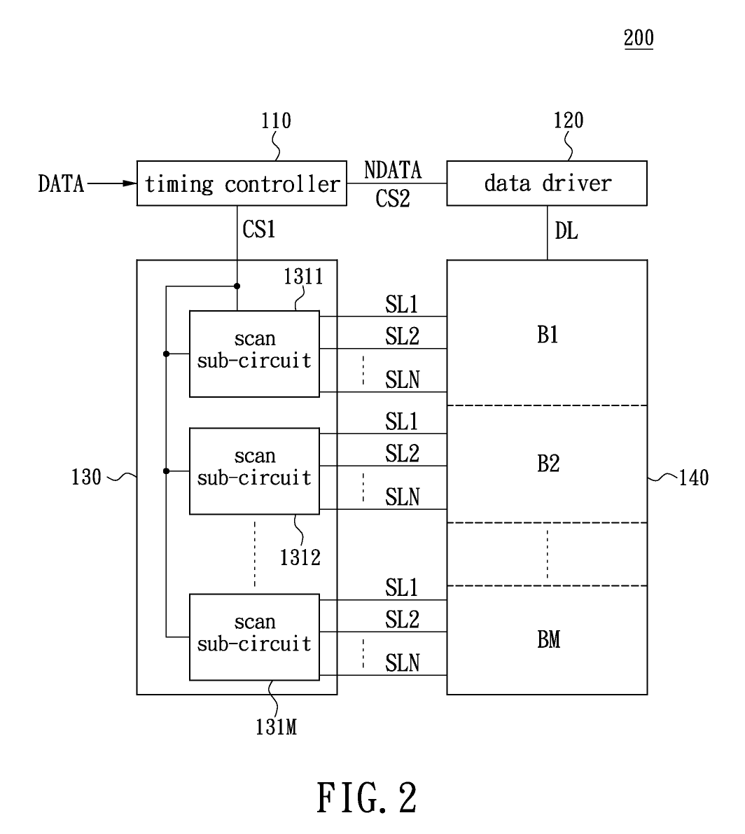

Referring to FIG. 2, FIG. 2 shows a schematic diagram of a liquid crystal display apparatus 200 according to another embodiment of the instant disclosure. Different from the embodiment in the FIG. 1, a scan driver 130 includes a plurality of scan sub-circuits 1311-131N, and a display panel 140 is divided into display blocks B1-BM corresponding to the plurality of the scan sub-circuits 1311-131M. According to a control signal CS1 received and through N scan lines SL1-SLN, each of the plurality of scan sub-circuits 1311-131M transmits N scan driving signals to the corresponding display blocks B1-BM. Moreover, according to the control signal CS1 received, each of the plurality of the scan sub-circuits 1311-131M adjusts a sequence of scan driving of a scan driving signal so as to correspond to a scan driving mode or to correspond to a sequence of a new display data NDATA. It is worth mentioning that in the present embodiment, for an easy instruction and understanding of the instant disclosure, numbers of the scan lines coupled to the scan sub-circuits 1311-131 are equal; however, in another embodiment, numbers of the scan lines coupled to the scan sub-circuits may be not equal to each other or only partly equal, and thus it is not limited thereto.

Furthermore, after the timing controller 110 receiving the original display data DATA, the timing controller 110 is able to be adopted with two or more than two scan driving modes to adjust the sequence of the original display data DATA, and a new display data NDATA is generated and transmitted to the data driver 120. In the meantime, the timing controller 110 according to the scan driving mode adopted to transmit the control signal CS1 to the scan sub-circuits 1311-131M, and according to a sequence adjusting information carried by the control signal CS1, the scan sub-circuits 1311-131M adjusts the sequence of scan driving of the scan driving signal so as to correspond to the scan driving modes respectively. Then, each of the scan sub-circuits 1311-131M through the scan lines SL1-SLN transmits the scan driving signal to the display blocks B1-BM corresponded in the display panel 140. Thus, when the timing controller 110 is adopted with different kinds of scan driving modes, the scan driving modes corresponding to the display bocks B1-BM are also different from each other.

In an embodiment, the timing controller 110 is also able to adjust a display information of display blocks B1-BM according to an information stored in a frame register. The sequence adjusting information is able to be transmitted to the scan sub-circuits 1311-131N along with the control signal CS1. Surely, a designer is also able to design that the sequence adjusting information to be transmitted to each of the scan sub-circuits 1311-131M through a sequence adjusting line (not shown in Figs), and thus the instant disclosure is not limited thereto.

To describe more details of the driving method which is adopted to the liquid crystal display apparatus 200 and is able to improve the operating temperature, there is further instruction made by a more specific quantitative example (N=4, and M=2) as follows. Generally, when a system is operated together with a big-sized liquid crystal display panel, patterns are used to determine whether an operating temperature is over high. There is one of the patterns described as follows for a use of an instruction example, and it is not limited thereto.

### Embodiment of Another Liquid Crystal Display Apparatus

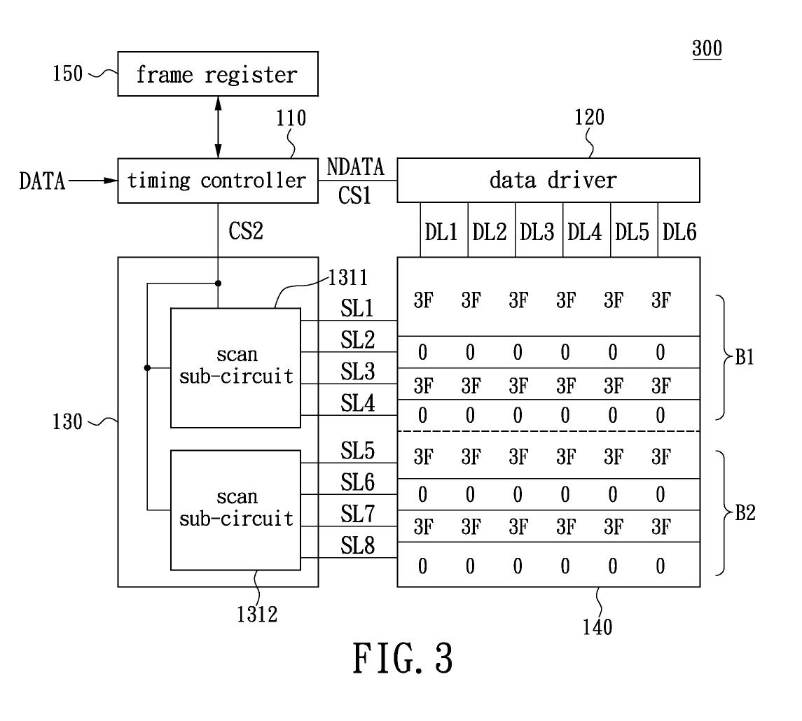

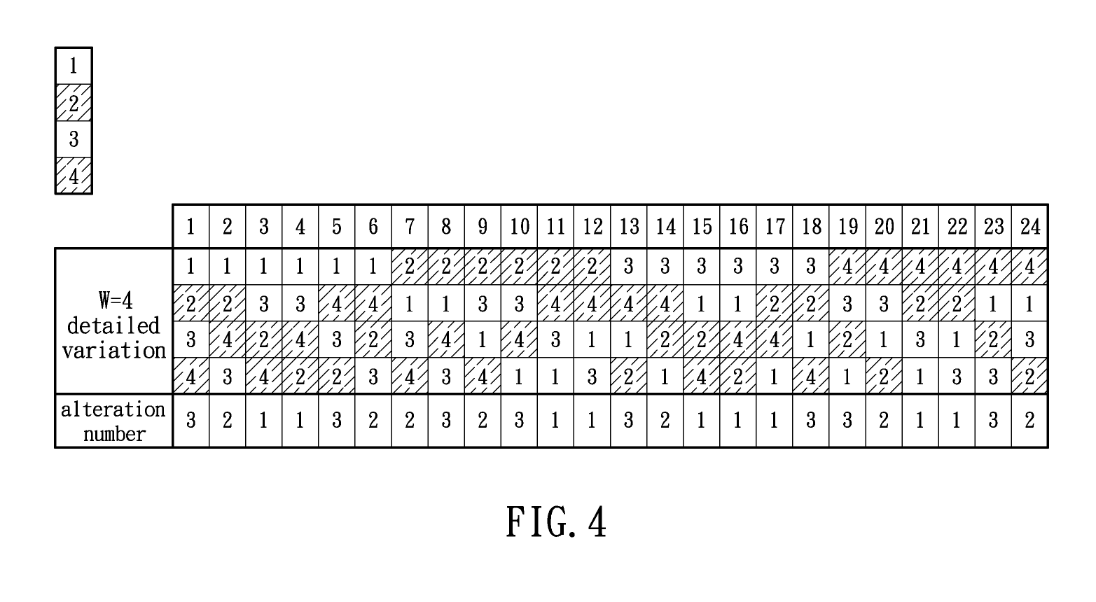

Referring to FIGS. 3 and 4, FIG. 3 shows a schematic diagram of a liquid crystal display apparatus according to another embodiment of the instant disclosure. FIG. 4 shows a chart of a scan driving mode according to the embodiment of the instant disclosure; before instruction, it is clarified that the following example is assumed that a scan driver 130 has two scan sub-circuits 1311-1312, and the display panel 140 is divided into two display blocks B1-B2, wherein the display block B1 has four scan lines SL1-SL4 coupled to the scan sub-circuit 1311; the display block B2 has four scan lines SL5-SL8 coupled to the scan sub-circuit 1312, wherein the scan sub-circuits 1311 and 1312 correspond to the same scan driving mode; however, in another embodiment, the scan sub-circuits 1311 and 1312 may correspond to different scan driving modes, and it is not limited thereto. The display panel 140 has six data lines DL1-DL6, coupled to the data driver 120. There is a symbol “3F” of the display panel 140 standing for a light spot of a positive polarity or a negative polarity and representing for a high level voltage. There is another symbol “0” of the display panel 140 standing for a dark spot and representing for a low level voltage.

In the chart of FIG. 4, to show the results of all the scan driving modes operated as the scan lines of 4 (N=4), wherein areas with oblique lines stand for dark spots shown, and areas without oblique lines stand for light spots shown. Numbers (such as 1-2-3-4 or 1-2-4-3) stand for a sequence of scan driving of a scan driving signal transmitted by scan lines SL1-SL4 or SL5-SL8; for example, 1-2-4-3 means the sequence of scan driving of the scan driving signal to be from the scan line SL1, to the scan line SL2, and to the scan line SL4, and then to the scan line SL3. Furthermore, FIG. 4 shows an alteration number of a high-low level voltage performed by every possible scan driving mode corresponded. The higher the alteration number is; the more the power consumption of the data driver 120 is, and as a result, the higher the operating temperature of the data driver 120 will be. In the present embodiment, there are 24 kinds of the scan driving modes, wherein 8 kinds of which result in the alteration number of 3 (that is, the operating temperature to be the same as the original situation), and the rest 16 kinds of the scan driving modes result in the alteration number of less than 3 (i.e. the alteration number of 2 or 1, and which means the operating temperature is reduced). Therefore, if it is intended to reduce the operating temperature of the liquid crystal display apparatus 300, then a scan driving mode which is able to result in an operating temperature of less than 3 is adopted by the liquid crystal display apparatus 300.

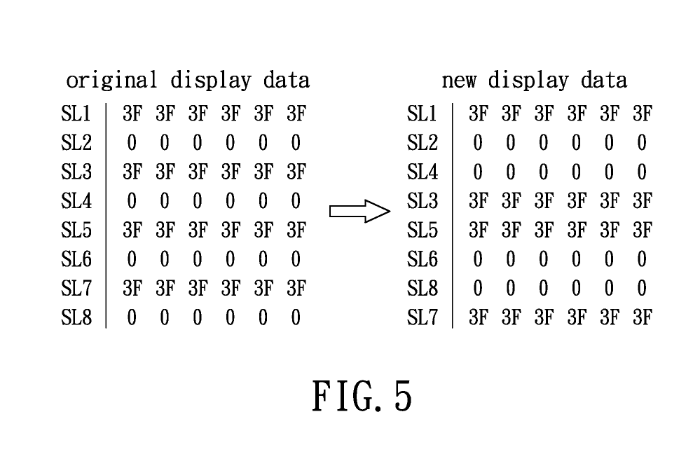

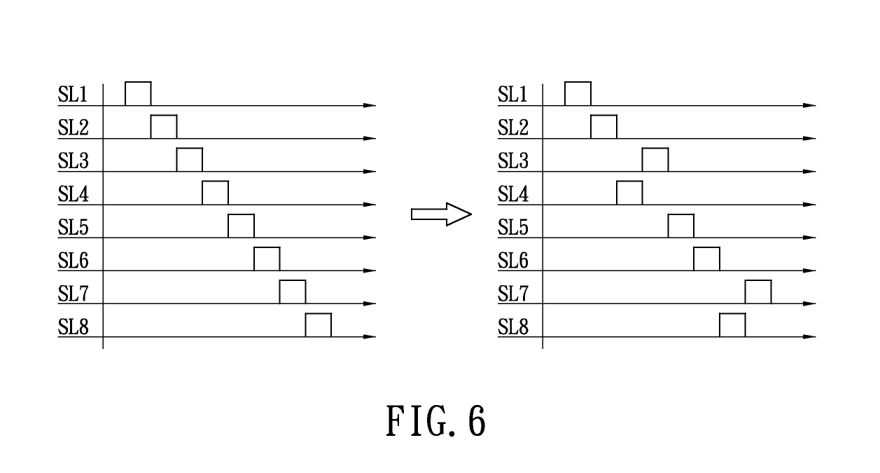

As following, there is an example describing when the scan sub-circuits 1311 and 1312 are adopted with the scan driving mode of the second kind, as shown in FIG. 4. When the timing controller 110 receives an original display data DATA, the timing controller 110 rearranges the original display data DATA received according to the scan driving mode (1-2-4-3). Referring to FIG. 5, FIG. 5 shows a schematic diagram of a timing controller rearranging an original display data according to the embodiment of the instant disclosure. As shown in FIG. 5, according to the scan driving mode (1-2-4-3), the timing controller 110 rearranges the original display data DATA by exchanging a third row with a fourth row, and exchanging a seventh row with the eighth row, and as a result, a new display data NDATA is generated and transmitted to the data driver 120 along with a control signal CS1. In the meantime, according to the scan driving mode (1-2-4-3), the timing controller 110 transmits the control signal CS1 to the scan sub-circuits 1311-1312 of the scan driver 130 to adjust a sequence of scan driving of the scan driving signal of the scan sub-circuits 1311-1312. Referring to FIG. 6, FIG. 6 shows a schematic diagram of the timing controller adjusting a sequence of scan driving according to the embodiment of the instant disclosure. As shown in FIG. 6, the scan sub-circuits 1311-1312 adjust the sequence of scan driving so as to correspond to the scan driving mode (1-2-4-3) by exchanging scan line SL3 with scan line SL4 and exchanging scan line SL7 and scan line SL8. In other words, the sequence of scan driving of the scan sub-circuit 1311 is adjusted from the original “from the scan line SL1, to the scan line SL2, and to the scan line SL3, and then to the scan line SL4” to be as “from the scan line SL1, to the scan line SL2, and to the scan line SL4, and then to the scan line SL3.” On the other hand, the sequence of scan driving of the scan sub-circuit 1312 is adjusted from the original “from the scan line SL5, to the scan line SL6, and to the scan line SL7, and then to the scan line SL8” to be as “from the scan line SL5, to the scan line SL6, and to the scan line SL8, and then to the scan line SL7.”

Therefore, under the scan driving mode 1-2-4-3, when the scan sub-circuit 1311 transmits the scan driving signal to the first row of the display bock B1 through the scan line SL1, the data driver 120 transmits the first row of the new display data NDATA to the first row of the display block B1 of the display panel 140 through the data lines DL1-DL6. Then, when the scan sub-circuit 1311 transmits the scan driving signal to the second row of the display bock B1 of the display panel 140 through the scan line SL2, the data driver 120 transmits the second row of the new display data NDATA to the second row of the display block B1 through the data lines DL1-DL6. Afterwards, when the scan sub-circuit 1311 transmits the scan driving signal to the fourth row of the display bock B1 of the display panel 140 through the scan line SL4, the data driver 120 transmits the third row of the new display data NDATA to the fourth row of the display block B1 through the data lines DL1-DL6. Finally, when the scan sub-circuit 1311 transmits the scan driving signal to the third row of the display bock B1 of the display panel 140 through the scan line SL3, the data driver 120 transmits the fourth row of the new display data NDATA to the third row of the display block B1 through the data lines DL1-DL6.

When the scan sub-circuit 1312 transmits the scan driving signal to the first row of the display bock B1 through the scan line SL5, the data driver 120 transmits the first row of the new display data NDATA to the fifth row of the display block B1 of the display panel 140 through the data lines DL1-DL6. Then, when the scan sub-circuit 1311 transmits the scan driving signal to the second row of the display bock B1 of the display panel 140 through the scan line SL6, the data driver 120 transmits the sixth row of the new display data NDATA to the second row of the display block B1 through the data lines DL1-DL6. Afterwards, when the scan sub-circuit 1311 transmits the scan driving signal to the fourth row of the display bock B1 of the display panel 140 through the scan line SL8, the data driver 120 transmits the seventh row of the new display data NDATA to the fourth row of the display block B1 through the data lines DL1-DL6. Finally, when the scan sub-circuit 1311 transmits the scan driving signal to the third row of the display bock B1 of the display panel 140 through the scan line SL7, the data driver 120 transmits the eighth row of the new display data NDATA to the third row of the display block B1 through the data lines DL1-DL6.

It is worth mentioning that if the liquid crystal display apparatus 300 is under a scan driving mode whose alteration number is 1 (such as the third kind, 1-3-2-4, as shown in FIG. 4), then there is a better effect of power saving achieved, comparing to an effect of power saving achieved under the scan driving mode with a alteration number of 2; which means, the operating temperature of the data driver 120 is even reduced more. Moreover, in the present embodiment, the scan sub-circuits 1311 and 1312 are allowed to be under different kinds of scan driving mode; for example, the scan sub-circuit 1311 is under the scan driving mode of the sixth kind, 1-4-2-3, as shown in FIG. 4, while the scan sub-circuit 1312 is under the scan driving mode of the seventeenth kind, 3-2-4-1, as shown in FIG. 4.

In an embodiment, the liquid crystal display apparatus 300 further includes a frame register 150, so that the timing controller 110 is further able to adjust the display data of display blocks B1 and B2 according to an information stored in the frame register 150. For example, as the same situation, under the scan driving mode 1-2-4-3, the scan sub-circuit 1312 first outputs a scan driving signal to the display block B2, and a sequence of scan driving is from the scan line SL5, to the scan line SL6, and to the scan line SL8, and finally to the scan line SL7; afterwards, the scan sub-circuit 1311 outputs the scan driving signal to the display block B1, and a sequence of scan driving is from the scan line SL1, to the scan line SL2, and to the scan line SL4, and finally to the scan line SL3. In the meantime, the timing controller 100 according to the data in the scan driving mode (1-2-4-3) and the frame register 150 to rearrange an original display data DATA, and that is, as shown in FIG. 5, to exchange the first 4 rows of a new display data NDATA for the rest 4 rows of the new display data NDATA, so as to correspond to the sequence of scan driving of the scan lines SL1-SL8.

In comparison to the prior arts, for a size of a display panel getting bigger, then a resolution of the display panel is getting higher, and a RC loading of the display panel is getting more, which leads to operating temperatures of all driving circuits also get higher; therefore, the instant closure provides a liquid crystal display apparatus and the driving method thereof, which decreases a number of a high-low level voltage alteration without an image variation when the display panel showing an image data, and further reduces the operating temperature of the data driver.

### Embodiment of a Driving Mode

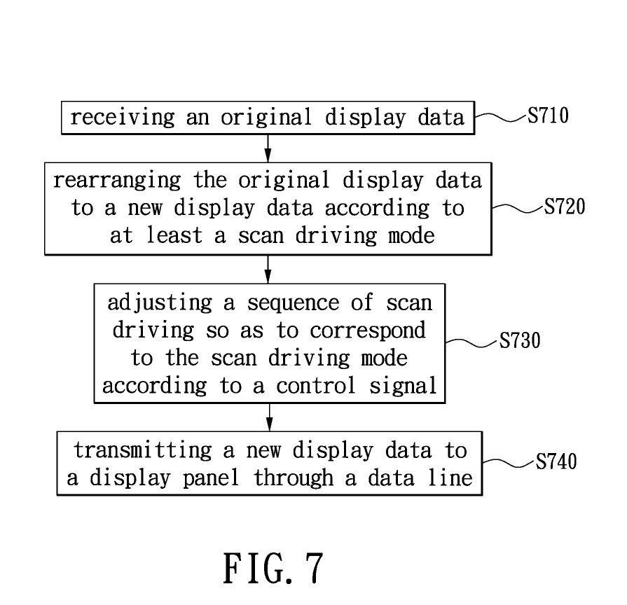

Referring to FIG. 7, FIG. 7 shows a flow chart of a driving mode according the embodiments of the instant disclosure. The driving mode of the embodiment is suitable for each of the liquid crystal display apparatus in the embodiments shown in FIGS. 1-3; therefore, please refer to FIGS. 1-3 for better understanding. In the present embodiment, steps of improving an operating temperature are described as follows: receiving an original display data (S710); rearranging the original display data to a new display data according to at least a scan driving mode (S720); adjusting a sequence of scan driving so as to correspond to the scan driving mode according to a control signal (S730); transmitting a new display data to a display panel through a data line (S740), wherein the sequence of the original display data corresponds to the sequence of scan driving before adjusting, and a sequence of the new display data corresponds to the sequence of scan driving after adjusting according to the scan driving mode.

As for related details in the steps of the driving method of the liquid crystal display apparatus, there are specific instructions of the embodiments in the FIGS. 1-6 as described above, and thus it is not repeated thereto. However, it is noticed that the steps of the present embodiment in FIG. 7 are set for a need to instruct easily, and thus the sequence of the steps is not used as a condition to limit the demonstration of the embodiments of the instant closure.

To sum up, the instant closure provides a liquid crystal display apparatus and the driving method thereof, which decreases a number of a high-low level voltage alteration without an image variation on the display panel, and economizes an overall power consumption of the liquid crystal apparatus, and further reduces the operating temperature of the data driver.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A liquid crystal display apparatus, comprising:
a display panel;
a timing controller, receiving an original display data and rearranging the original display data to be as a new display data according to at least a scan driving mode;
a data driver, coupled to the timing controller, receiving the new display data and transmitting the new display data to a display panel through a data line; and
a scan driver, coupled to the timing controller, receiving a control signal transmitted by the timing controller and adjusting a sequence of scan driving so as to correspond to the scan driving mode according to a control signal;
wherein a sequence of the original display data corresponds to the sequence of scan driving before adjusting, and a sequence of the new display data corresponds to the sequence of scan driving after adjusting.

2. The liquid crystal display apparatus according to claim 1, wherein when the timing controller rearranges the original display data according to the scan driving mode, the timing controller transmits the control signal to the scan driver to adjust the sequence of scan driving according to the scan driving mode.

3. The liquid crystal display apparatus according to claim 1, wherein the scan driver includes M scan sub-circuits, and the display panel is divided into M display blocks; according to the control signal, each of the scan sub-circuits transmits N scan driving signals to the display block corresponded, wherein M and N are positive integers.

4. The liquid crystal display apparatus according to claim 3, wherein each of the scan sub-circuits adjusts the sequence of scan driving so as to correspond to the scan driving mode.

5. The liquid crystal display apparatus according to claim 3, wherein the timing controller adjusts a sequence of display in the display blocks according to an information stored in a frame register.

6. A driving mode, suitable for a liquid crystal display apparatus, the driving mode comprising:
receiving an original display data;
rearranging the original display data to a new display data according to at least a scan driving mode;
adjusting a sequence of scan driving so as to correspond to the scan driving mode according to a control signal; and
transmitting a new display data to a display panel through a data line;
wherein a sequence of the original display data corresponds to the sequence of scan driving before adjusting, and a sequence of the new display data corresponds to the sequence of scan driving after adjusting according to the scan driving mode.

7. The driving mode according to claim 6, wherein when rearranging the original display data according to the scan driving mode, a timing controller transmits the control signal to a scan driver to adjust the sequence of scan driving according to the scan driving mode.

8. The driving mode according to claim 6, wherein the scan driver includes M scan sub-circuits, and the display panel is divided into M display blocks; according to the control signal, each of the scan sub-circuits transmits N scan driving signals to the display block corresponded, wherein M and N are positive integers.

9. The driving mode according to claim 8, wherein each of the scan sub-circuits adjusts the sequence of scan driving so as to correspond to the scan driving mode.

10. The driving mode according to claim 8, wherein the timing controller adjusts a sequence of display in the display blocks according to an information stored in a frame register.
